(19) United States
(12) Patent Application Publication
(10) Pub. No.: US 2018/0048774 A1
(43) Pub. Date: Feb. 15, 2018

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Haruhisa HOSHINO, Kanagawa (JP)

(73) Assignee: FUJI XEROX CO., LTD., Tokyo (JP)

(21) Appl. No.: 15/440,743

(22) Filed: Feb. 23, 2017

(30) Foreign Application Priority Data
Aug. 9, 2016 (JP) 2016-156354

(51) Int. Cl. H04N 1/00; H04N 1/32; G06F 3/12

(52) U.S. Cl. CPC H04N 1/00411; G06F 3/1205; H04N 1/32358; H04N 2201/0094

(57) ABSTRACT

An information processing apparatus includes a generation unit and a display controller. The generation unit generates, in units of a group of pages, reduced images of pages included in a document image, the number of pages of the group of pages being determined on the basis of a hardware resource to be used in reduced-image generation. The display controller controls display of the reduced images generated by the generation unit on a display.

### CROSS-REFERENCE TO RELATED APPLICATIONS

This application is based on and claims priority under 35 USC 119 from Japanese Patent Application No. 2016-156354 filed Aug. 9, 2016.

### BACKGROUND

### Technical Field

The present invention relates to an information processing apparatus, an information processing method, and a non-transitory computer readable medium.

### SUMMARY

According to an aspect of the invention, there is provided an information processing apparatus including a generation unit and a display controller. The generation unit generates, in units of a group of pages, reduced images of pages included in a document image, the number of pages of the group of pages being determined on the basis of a hardware resource to be used in reduced-image generation. The display controller controls display of the reduced images generated by the generation unit on a display.

### BRIEF DESCRIPTION OF THE DRAWINGS

An exemplary embodiment of the present invention will be described in detail based on the following figures, wherein:

FIG. 1 is a block configuration diagram of an image forming apparatus according to the present exemplary embodiment;

FIG. 2 is a hardware configuration diagram of the image forming apparatus according to the present exemplary embodiment;

FIG. 3 is a diagram used to describe a determination method for the number of pages of a group of pages in the present exemplary embodiment;

FIG. 4 is a schematic diagram illustrating an example of screen display performed when preview images are displayed on an operation panel in the present exemplary embodiment;

FIG. 5 is a schematic diagram illustrating an example of screen display performed when the last page included in the group of pages that is being displayed is displayed in the present exemplary embodiment;

FIG. 6 is a schematic diagram illustrating an example of screen display performed when preview images of pages included in a new group of pages are displayed in the present exemplary embodiment;

FIG. 7 is a schematic diagram illustrating an example of screen display performed when preview images of pages included in the group of pages including the last page of a document are displayed in the present exemplary embodiment;

FIG. 8 is a schematic diagram illustrating an example of screen display in the case where an operation region for displaying operation parts is provided in addition to a display region for preview images; and

FIG. 9 is a schematic diagram illustrating another example of screen display in the case where the operation region for displaying the operation parts is provided in addition to the display region for preview images.

### DETAILED DESCRIPTION

In the following, an exemplary embodiment of the present invention will be described with reference to the drawings.

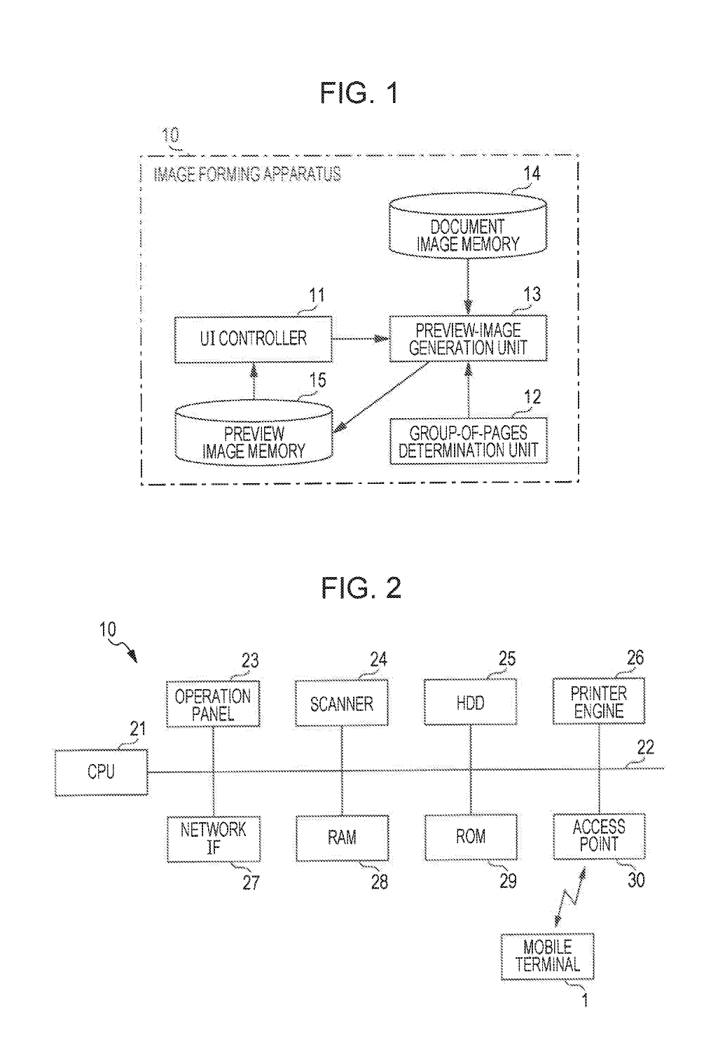

FIG. 1 is a block configuration diagram of an image forming apparatus 10 according to the present exemplary embodiment. FIG. 2 is a hardware configuration diagram of the image forming apparatus 10 according to the present exemplary embodiment. The image forming apparatus 10 is a multifunction machine with various functions such as a copy function and a scanner function, and includes a computer. In FIG. 2, a central processing unit (CPU) 21 controls, in accordance with programs stored in a read-only memory (ROM) 29, operations of various mechanisms installed in the image forming apparatus 10, examples of the various mechanisms including a scanner 24 and a printer engine 26. An address data bus 22 is connected to the various mechanisms to be controlled by the CPU 21, and data communication is performed therethrough. An operation panel 23 is a user interface unit serving as a receiving unit that receives commands from a user and as a display that displays information. The scanner 24 reads a document set by the user and stores the resulting data as electronic data in a hard disk drive (HDD) 25 or the like. The HDD 25 stores an electric document and the like read by using the scanner 24. The printer engine 26 prints images on output paper in accordance with commands from a certain control program executed by the CPU 21. A network interface (IF) 27 is connected to a network and is used, for example, to transmit electronic data generated by the image forming apparatus 10, to receive e-mails transmitted and addressed to the image forming apparatus 10, and to access the image forming apparatus 10 via a browser. A random-access memory (RAM) 28 is used as a work memory for when a program is being executed and as a communication buffer for when electronic data is transmitted and received. The ROM 29 stores various programs regarding control of the image forming apparatus 10, encryption of electronic data, and transmission-reception of electronic data. As a result of execution of the various programs, the constituent elements to be described later realize certain processing functions. An access point 30 is a wireless communication unit that connects network devices such as a mobile terminal 1 to the image forming apparatus 10, that has an access point function, and that performs wireless communication based on Wi-Fi Direct®.

Returning to FIG. 1, the image forming apparatus 10 according to the present exemplary embodiment includes a user interface (UI) controller 11, a group-of-pages determination unit 12, a preview-image generation unit 13, a document image memory 14, and a preview image memory 15. Note that the constituent elements that are not described in the present exemplary embodiment are omitted in FIG. 1. The UI controller 11 serves as a display controller that receives the content of an input or an operation from the operation panel 23 and that performs display control for information such as preview images on the operation panel 23. The group-of-pages determination unit 12 serves as a determination unit that determines the number of pages of a group of pages to be described later. The preview-image generation unit 13 serves as a generation unit that generates preview images of the pages included in a document image in units of the group of pages the number of pages of which has been determined on the basis of hardware resources to be used to generate the preview images that are an example of reduced images. The document image memory 14 stores the document image whose preview images are displayed on the operation panel 23. The preview image memory 15 stores the preview images generated by the preview-image generation unit 13.

The constituent elements 11 to 13 in the image forming apparatus 10 are realized by performing a coordination operation using the computer included in the image forming apparatus 10 and the programs operated by the CPU 21 installed in the computer. In addition, the document image memory 14 and the preview image memory 15 are realized by the RAM 28 or the HDD 25 installed in the image forming apparatus 10. Alternatively, an external memory may be used via the network.

The programs used in the present exemplary embodiment may also be, as a matter of course, provided by a communication unit, and may also be stored in and provided as a computer readable medium such as a CD-ROM or a USB memory. The programs provided by the communication unit or from the recording medium are installed in the computer, and various processes are realized by the CPU 21 of the computer sequentially executing the programs.

Here, preview images of pages are generated in units of a “group of pages” in the present exemplary embodiment and the number of pages of the group of pages is the number of pages of preview images to be generated in a single generation process. When the pages of the document image are displayed on the operation panel 23, the preview images of the pages included in the document image are generated and displayed on the operation panel 23 in the present exemplary embodiment due to a relationship between the operation panel 23 and the document image in terms of resolution. In the case where the number of pages of the document image is large, the preview images of all the pages are not collectively generated in the present exemplary embodiment but are generated over several sessions as necessary by considering the specifications for the hardware resources such as the CPU performance and the amount of storage of the image forming apparatus 10. Multiple pages to be processed per single preview-image generation process is referred to as “group of pages”. For example, in the case where the number of pages of the group of pages is determined to be 10 pages, when preview images of a 24-page document image are generated, preview images of 10 pages (the 1st to 10th pages) included in the first group of pages are generated at first, and preview images of 10 pages (the 11th to 20th pages) included in the next group of pages are generated in accordance with a display request for the next group of pages. Thereafter, preview images of the 21st to 24th pages included in the following group of pages are generated in accordance with a display request for the following group of pages. In this manner, preview images are generated in units of the group of pages and are to be displayed on the operation panel 23 in the present exemplary embodiment. Note that, for the preview images to be displayed, all the pages are not always displayed at once depending on the size of the screen of the operation panel 23, and may also be displayed by scrolling the screen or the like.

As described above, the preview images of the pages included in the document image are generated and displayed on the operation panel 23 in the present exemplary embodiment. A characteristic of the present exemplary embodiment is to determine units of preview-image generation, that is, the number of pages of the group of pages on the basis of the hardware resources to be used in preview-image generation. When the size of preview images is fixed for the sake of description, the number of preview images that may be collectively displayed at once depends on the screen size of the operation panel 23.

The number of pages for collective generation of preview images (the group of pages) is determined in the present exemplary embodiment by considering not only the relationship between the specifications for the screen such as the size and resolution of the operation panel 23 and the resolution of preview images but also hardware resources to be used to generate the preview images, specifically the processing performance of the CPU 21 and the amount of storage of a memory such as the RAM 28 or the HDD 25 for storing preview images. In the following, a determination method for the number of pages of the group of pages will be described, the group-of-pages determination method being performed by the group-of-pages determination unit 12.

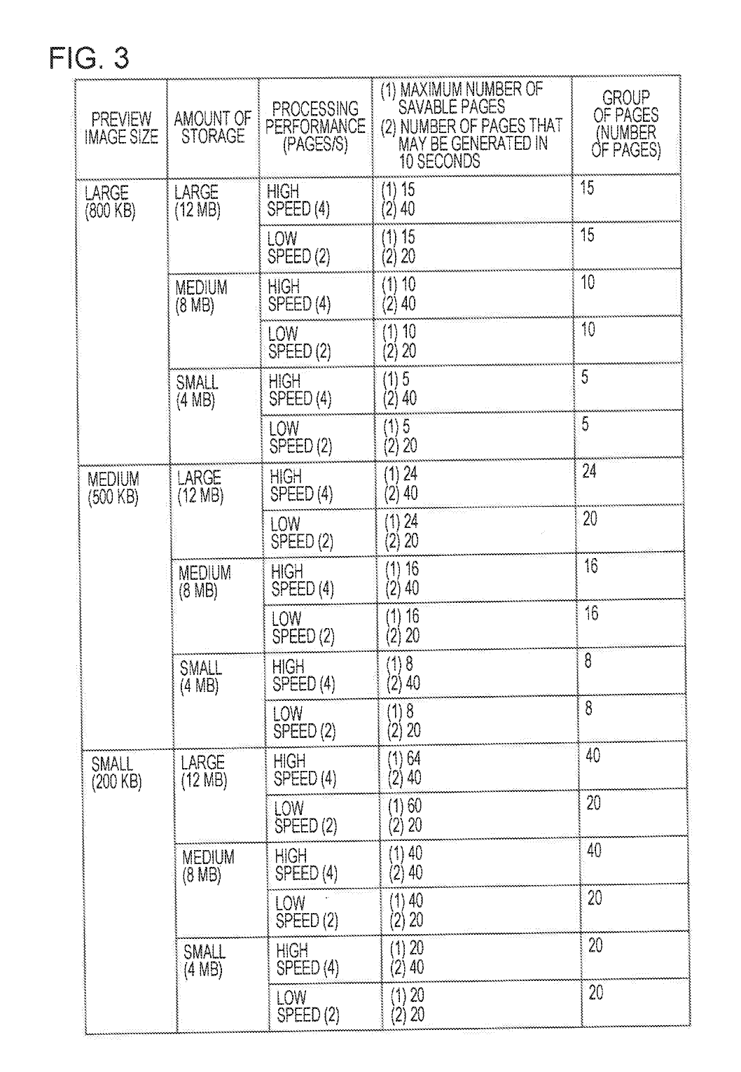

FIG. 3 is a diagram used to describe a determination method for the number of pages of the group of pages. In FIG. 3, “preview image size” is a preview-image data size (the size of a preview image acquired from the size of preview image data), and this is determined on the basis of the resolution of the operation panel 23. For example, in the case where the resolution of the operation panel 23 is relatively high, when the resolution of a preview image is low, the display size of the preview image becomes small. As a result, it is necessary to generate the preview image with a relatively high resolution, and thus the size of generated preview image data becomes large. The maximum size of preview image data may be calculated from the resolution of the operation panel 23, and for example the maximum data size is 800 KB when the operation panel 23 has a high resolution. In contrast, in the case where the resolution of the operation panel 23 is relatively low, even when the resolution of a preview image is low, the preview image is displayed somewhat larger. As a result, the preview image may be generated with a relatively low resolution, and thus the maximum size of generated preview image data becomes small. For example, in the case of a low-resolution operation panel, the maximum data size is 200 KB. The size of intermediate preview-image data is, for example, 500 KB.

“Amount of storage” is the amount of storage available for a preview function. In the present exemplary embodiment, when a description is made assuming that preview images are to be loaded into the RAM 28, the amount of storage is the amount of space of the RAM 28 available for generation of the preview images and storage of the generated preview images. The capacity of the RAM 28 is used for the sake of brevity in the present exemplary embodiment; however, strictly speaking, the amount of storage obtained by subtracting the amount of storage to be used by a system or other applications from the capacity of the RAM 28 or the amount of storage set in advance and allocated to the preview function may also be set in a table illustrated in FIG. 3.

“Processing performance” indicates the processing performance of the CPU 21. In the present exemplary embodiment, the processing performance is represented as a measure that is the number of pages that may be generated per second.

In FIG. 3, “(1) maximum number of savable pages” indicates the maximum number of preview images savable in the RAM 28. Page images are associated with preview images on a one-to-one basis, and thus the number of preview images is the same as the number indicated by the number of pages. When the preview image size is 800 KB and the amount of storage is 12 MB, the maximum number of savable pages is calculated as 12 MB/800 KB=15 pages.

In FIG. 3, “(2) number of pages that may be generated in 10 seconds” indicates the number of preview images that may be generated (the number of pages of preview images that may be generated) within a certain time (10 seconds). When the processing performance is 4 pages/s, the preview-image generation unit 13 may generate preview images of 40 pages in 10 seconds (4 pages/s×10 seconds=40 pages). “Group of pages” indicates the number of pages constituting the group of pages based on a relationship between the preview image size, the amount of storage, and the processing performance illustrated in FIG. 3. To “group of pages”, the smaller one of the value of “(1) maximum number of savable pages” and that of “(2) number of pages that may be generated in 10 seconds” is set.

According to the relationships between the preview image size and the hardware resources illustrated in FIG. 3, the group-of-pages determination unit 12 determines, for example, the number of pages of the group of pages to be 15 pages in the case where the preview image size is 800 KB and where the amount of storage is large and the processing performance indicates a high speed.

As described above, the determination method for the number of pages of the group of pages has been described using FIG. 3 in the present exemplary embodiment. Although numerical values are illustrated as an example such as large (12 MB), medium (8 MB), and small (4 MB) for the amount of storage and high (4 pages/s) and low (2 pages/s) for the processing performance and some combination patterns are illustrated in FIG. 3, this is an example. The group-of-pages determination unit 12 may determine the number of pages of the group of pages with reference to FIG. 3, and may also determine the number of pages of the group of pages by confirming, at every timing at which the image forming apparatus 10 is started, the specifications for the hardware resources such as the resolution of the operation panel 23, the processing performance of the CPU 21, and the amount of storage of the memory such as the RAM 28 or the HDD 25.

In addition, the present exemplary embodiment has been described in which 10 seconds are used as an example of the certain time for calculating the processing performance of the CPU 21 regarding preview-image generation; however, the certain time does not have to be limited to 10 seconds. For example, a time of about a few seconds that does not cause the user to experience stress before display of preview images may also be used.

Next, a preview-image display method according to the present exemplary embodiment will be described. Note that, here, the document image has 18 pages, and the number of pages of the group of pages is determined to be 10 pages.

For example, the user causes the scanner 24 to read multiple pages (here 18 pages) of the document in order to transmit the document by FAX. The read images (the document image) are stored in the document image memory 14. After the document is read, the preview-image generation unit 13 then generates preview images of the pages included in the document image. Here, since the number of pages of the group of pages has been determined to be 10 pages, the preview-image generation unit 13 generates in advance preview images of 10 pages (the 1st to 10th pages) starting from the 1st page among the 18 pages and registers the generated preview images in the preview image memory 15. Preview images of the 11th to 18th pages are not generated.

When the user inputs a certain operation command for causing the operation panel 23 to display the document image, the UI controller 11 reads out the preview images generated in advance from the preview image memory 15 and causes the operation panel 23 to display the preview images in accordance with a display request based on the operation performed by the user, the number of pages of the preview images generated in advance being the same as that of the group of pages.

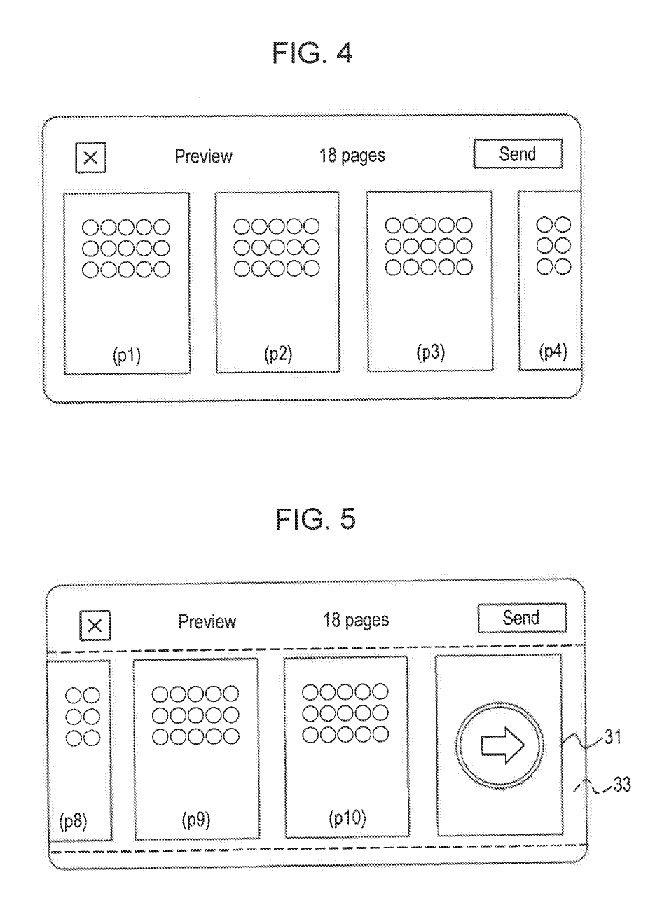

FIG. 4 is a schematic diagram illustrating an example of screen display performed when preview images are displayed on the operation panel 23. When preview images are generated, the UI controller 11 causes the operation panel 23 to display all or some of the generated preview images. As illustrated in FIG. 4, only some of the generated preview images may be displayed due to a relationship between the screen size of the operation panel 23 and the number and size of the preview images. In this case, the user confirms the read images by, for example, performing a certain scrolling operation to display the undisplayed preview images.

FIG. 5 is a schematic diagram illustrating an example of screen display when scrolling is performed to the last page included in the group of pages that is being displayed. In FIG. 5, a “next” button 31 serving as a group-of-pages switching part for displaying the group of pages placed immediately after the group of pages that is being displayed is displayed together with preview images, and the user is notified that a group of pages exists immediately after the group of pages that is being displayed.

Here, when the user selects and operates the “next” button 31, the UI controller 11 receives the operation and notifies the preview-image generation unit 13 of reception of the operation. The preview-image generation unit 13 generates, in accordance with this notification, preview images of the group of pages commanded by the user, that is, preview images of the 11th to 18th pages included in the next group of pages among the 18 pages and registers the generated preview images in the preview image memory 15. Note that the preview-image generation unit 13 may serve as a deletion unit and may register preview images and also delete registered preview images that are no longer to be displayed from the preview image memory 15 to free storage space. The UI controller 11 reads out the preview images of the commanded group of pages from the preview image memory 15 and causes the operation panel 23 to display the preview images.

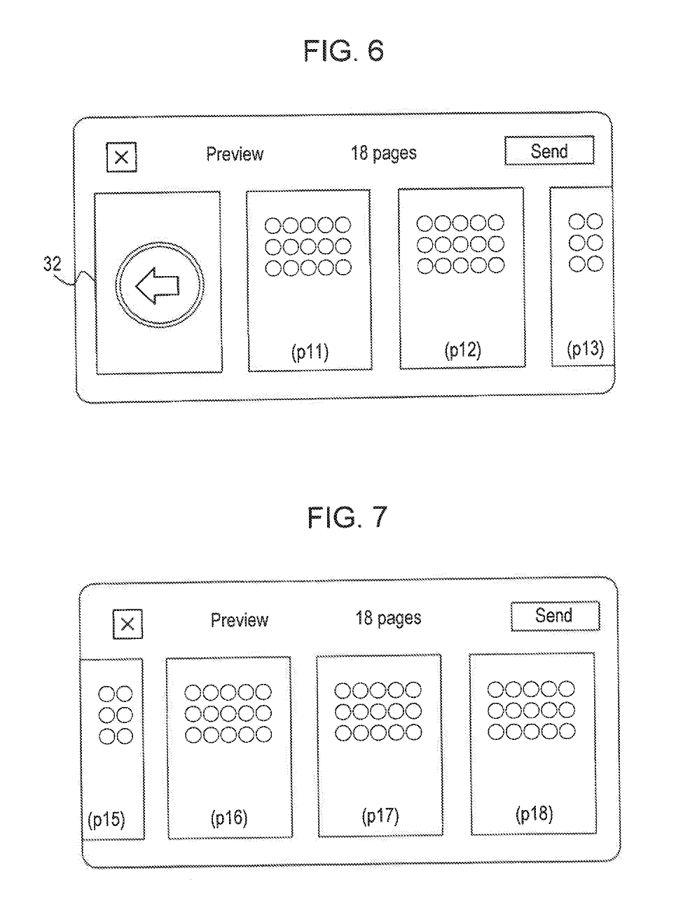

FIG. 6 is a schematic diagram illustrating an example of screen display performed when preview images of pages included in a new group of pages are displayed. As illustrated in FIG. 6, the UI controller 11 displays, together with the newly generated preview images, a “previous” button 32 serving as a group-of-pages switching part for displaying the group of pages placed immediately before the group of pages that is being displayed, the “previous” button 32 being displayed to the left of the preview images, and as a result notifies the user that a group of pages exists immediately before the group of pages that is being displayed.

The user confirms, in a manner similar to that described above, the read images by performing a certain scrolling operation to display the undisplayed preview images. FIG. 7 is a schematic diagram illustrating an example of screen display in this case. As illustrated in FIG. 7, when the preview image of the last page of the document image is being displayed, no more page (group of pages) exists after the preview image of the last page, and thus the UI controller 11 does not cause the “next” button 31 to be displayed unlike in FIG. 5. In addition, as illustrated in FIG. 4, no more page (group of pages) exists before the preview image of the top page that is being displayed, and thus the UI controller 11 does not cause the “previous” button 32 to be displayed unlike in FIG. 6.

The operation panel 23 according to the present exemplary embodiment has a wide shape as exemplified in FIGS. 4 to 7. The preview images are vertically oriented (displayed in portrait orientation), and thus a display region 33 illustrated with broken lines is provided on the screen to display preview images arranged horizontally as illustrated in FIG. 5, and scrolling display of the preview images is performed in the display region 33. Here, as exemplified in FIGS. 5 and 6, the “next” button 31 and the “previous” button 32 are displayed in the display region 33 in the present exemplary embodiment, the “next” button 31 and the “previous” button 32 serving as the group-of-pages switching parts for switching the group of pages that is being displayed to another group of pages.

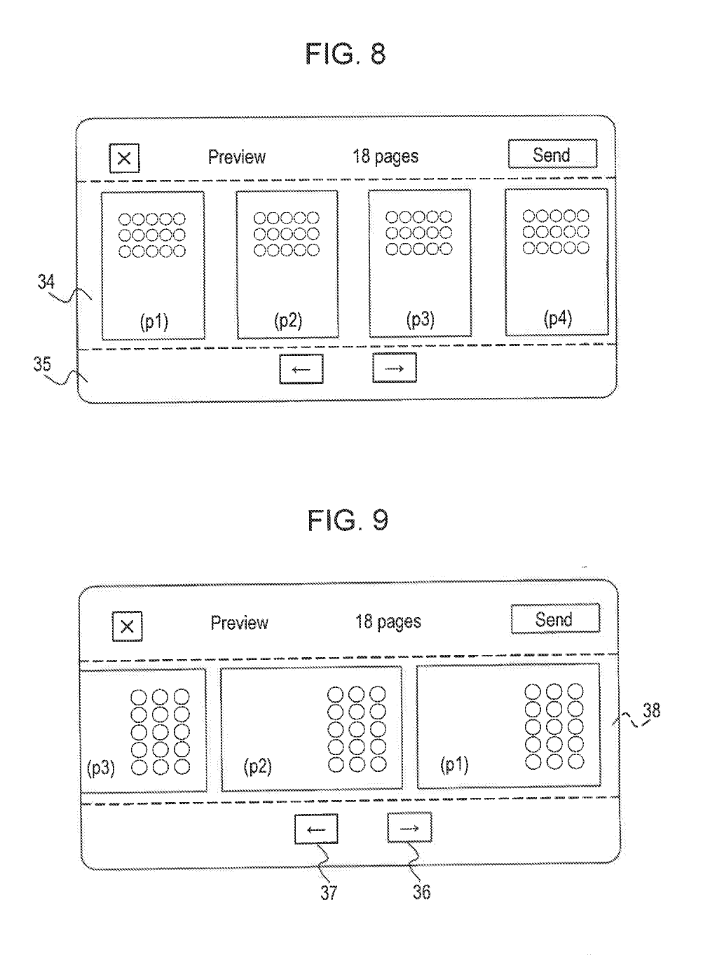

As exemplified in FIG. 8, in the case where a display region 35 for operation parts such as a “next” button and a “previous” button is provided in addition to a display region 34 for preview images, the display region 34 for preview images may not have a large space due to presence of the display region 35 for operation buttons. That is, as is clear from a comparison made with FIGS. 5 and 6, the preview images displayed in FIG. 8 may not be relatively large. That is, the operation parts such as the “next” button 31 and the “previous” button 32 are displayed in the display region 33 for preview images to make it possible to make the display size of the preview images larger in the present exemplary embodiment.

Note that the “next” button 31 and the “previous” button 32 are formed in the same size as that of the preview images to make it easier for the user to operate in FIGS. 5 and 6; however, the width of each button may be reduced and formed such that the entire 8th page in FIG. 5 or the entire 13th page in FIG. 6 is displayed on the screen.

On the other hand, as illustrated in FIG. 9, when preview images are horizontally oriented (displayed in landscape orientation) and the “next” button 31 and the “previous” button 32 are formed as above in the display region 33 for preview images, the number of preview images displayable on the screen is reduced. Thus, operation parts such as a “next” button 36 and a “previous” button 37 are displayed outside a display region 38 for preview images to make it possible to make the display size of the preview images larger in FIG. 9. In this manner, the display positions of the operation parts on the operation panel 23 may be determined in accordance with the orientation of the screen of the operation panel 23 and that of preview images.

In the case where the mobile terminal 1 is connected to the image forming apparatus 10 and used as a display, the number of pages of the group of pages is determined with reference to the specifications for the hardware resources of the mobile terminal 1.

Note that the “next” button 31 for displaying the group of pages placed immediately after the group of pages that is being displayed and the “previous” button 32 for displaying the group of pages placed immediately before the group of pages that is being displayed are illustrated as operation parts in the present exemplary embodiment; however, for example, other operation parts for switching display from the group of pages that is being displayed to the group of pages including the last page or to the group of pages including the top page may also be used.

In the present exemplary embodiment, the operation part or parts are displayed on the screen and a group-of-pages switching command is issued by the user performing an operation. The way in which the group-of-pages switching command is issued does not have to be limited to this way. For example, an operation command may also be issued, without using any operation part, by performing a predetermined gesture operation on the operation panel 23, examples of the gesture operation including tap, flick, and swipe operations on the operation panel 23.

As described above, a characteristic of the present exemplary embodiment is to determine the number of pages of the group of pages on the basis of the hardware resources to be used to generate and display preview images. However, the user may only want to confirm, for example, the top page or the first few pages. Assuming such a case, the group-of-pages determination unit 12 may serve as a setting unit that allows the user to set the number of pages of the group of pages. That is, the group-of-pages determination unit 12 commands, in accordance with a certain operation performed by the user, the UI controller 11 to cause the operation panel 23 to display a setting screen for inputting the number of pages of the group of pages. The number of pages input and specified by the user through the setting screen is set as the number of pages of the group of pages as is. As a result, the preview-image generation unit 13 generates preview images in units of the group of pages the number of pages of which has been input and specified by the user.

Note that the image forming apparatus 10 including a computer and having a scanned-image preview function has been described as an example of an information processing apparatus in the present exemplary embodiment; however; the present exemplary embodiment may also be applied to apparatuses other than the image forming apparatus 10 as long as the apparatuses are generic computers having a function for generating and displaying reduced images.

The foregoing description of the exemplary-embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a generation unit that generates, in units of a group of pages, reduced images of pages included in a document image, the number of pages of the group of pages being determined on the basis of a hardware resource to be used in reduced-image generation; and
a display controller that controls display of the reduced images generated by the generation unit on a display.

2. The information processing apparatus according to claim 1, further comprising a determination unit that determines, to be the number of pages of the group of pages, the smaller one of the number of pages savable in a memory used in the reduced-image generation and the number of pages of reduced images that the generation unit is capable of generating within a certain time.

3. The information processing apparatus according to claim 1, wherein
the generation unit generates, in advance, reduced images of one group of pages among the pages included in the document image, and
the display controller causes the display to display all or some of the reduced images generated in advance in accordance with a display request for the document image.

4. The information processing apparatus according to claim 1, wherein in a case where the display is an operation panel capable of receiving an operation performed by a user, the generation unit generates reduced images of pages included in a group of pages commanded through the operation performed by the user on the operation panel.

5. The information processing apparatus according to claim 4, wherein the generation unit generates reduced images of pages included in a group of pages commanded through a certain operation performed by the user on an operation part displayed on the operation panel.

6. The information processing apparatus according to claim 5, further comprising a deletion unit that deletes reduced images that are no longer displayed in accordance with the certain operation performed by the user on the operation part from a memory storing the reduced images.

7. The information processing apparatus according to claim 5, wherein in a case where the operation part is a group-of-pages switching part for display of a group of pages placed immediately after a group of pages that is being displayed, the generation unit generates reduced images of pages included in the group of pages placed immediately after the group of pages that is being displayed.

8. The information processing apparatus according to claim 5, wherein in a case where the operation part is a group-of-pages switching part for display of a group of pages placed immediately before a group of pages that is being displayed, the generation unit generates reduced images of pages included in the group of pages placed immediately before the group of pages that is being displayed.

9. The information processing apparatus according to claim 5, wherein the display controller determines a display position of the operation part on a screen of the display in accordance with an orientation of the screen of the display and an orientation of the reduced images.

10. The information processing apparatus according to claim 9, wherein in a case where the screen of the display is horizontally oriented and the reduced images are vertically oriented, the display controller causes the operation part to be displayed within a display region where the reduced images are horizontally arranged and displayed.

11. The information processing apparatus according to claim 9, wherein in a case where the screen of the display is horizontally oriented and the reduced images are horizontally oriented, the display controller causes the operation part to be displayed outside a display region where the reduced images are horizontally arranged and displayed.

12. The information processing apparatus according to claim 5, wherein in a case where no group of pages exists at least either immediately before or immediately after a group of pages that is being displayed and where the operation part is one of a plurality of operation parts displayed on the operation panel, the display controller performs control such that an operation part for display of a side where no group of pages exists is not displayed among the plurality of operation parts.

13. The information processing apparatus according to claim 12, wherein in a case where reduced images of a group of pages including a top page of the document image are being displayed, the display controller performs control such that an operation part for display of a group of pages placed immediately before the group of pages that is being displayed is not displayed among the plurality of operation parts.

14. The information processing apparatus according to claim 12, wherein in a case where reduced images of a group of pages including a last page of the document image are being displayed, the display controller performs control such that an operation part for display of a group of pages placed immediately after the group of pages that is being displayed is not displayed among the plurality of operation parts.

15. The information processing apparatus according to claim 4, wherein the generation unit generates reduced images of pages included in a group of pages commanded through a gesture operation performed by the user on the operation panel.

16. The information processing apparatus according to claim 1, further comprising a setting unit that allows a user to set the number of pages of the group of pages, wherein
in a case where the number of pages of the group of pages is set through the setting unit, the generation unit generates, in units of the group of pages the number of pages of which is set, the reduced images of the pages included in the document image.

17. The information processing apparatus according to claim 1, further comprising a connection unit that connects a network device having a display function to the image processing apparatus, wherein the network device is used as the display.

18. The information processing apparatus according to claim 17, further comprising a determination unit that determines the number of pages of the group of pages on the basis of a hardware resource of the network device.

19. An information processing method comprising:
generating, in units of a group of pages, reduced images of pages included in a document image, the number of pages of the group of pages being determined on the basis of a hardware resource to be used in reduced-image generation; and
controlling display of the reduced images generated in the generating on a display.

20. A non-transitory computer readable medium storing a program causing a computer to execute a process, the process comprising:
generating, in units of a group of pages, reduced images of pages included in a document image, the number of pages of the group of pages being determined on the basis of a hardware resource to be used in reduced-image generation; and
controlling display of the reduced images generated in the generating on a display.
